(19) United States
(12) Patent Application Publication
(10) Pub. No.: US 2022/0233954 A1
(43) Pub. Date: Jul. 28, 2022

(54) SYSTEM AND METHODS FOR GENERATING A PLATFORM-AGNOSTIC GAME SHORTCUT TO LAUNCH A GAME FOR CLOUD GAMING

(71) Applicant: Ping-Kang Hsiung, El Segundo, CA (US)

(72) Inventor: Ping-Kang Hsiung, El Segundo, CA (US)

(73) Assignee: Ping-Kang Hsiung, El Segundo, CA (US)

(21) Appl. No.: 17/616,480

(22) PCT Filed: Jun. 3, 2020
(86) PCT No.: PCT/US2020/035975

§ 371 Date: Dec. 3, 2021

Related U.S. Application Data
(60) Provisional application No. 62/856,150, filed on Jun. 3, 2019.

(51) Int. Cl. A63F 13/355; A63F 13/79; A63F 13/73

(52) U.S. Cl. CPC A63F 13/355; A63F 13/79; A63F 2300/538; A63F 2300/5546; A63F 13/73

(57) ABSTRACT

Embodiments of the present disclosure provide for systems and methods for generating a platform-agnostic game shortcut that, upon selection, automatically launches a cloud gaming game instance of a game. In operation, a computing device may receive user credentials associated with a user account of a cloud gaming server, as well as user credentials associated with a user account of a gaining platform hosted on the cloud gaming server. The computing device may bind the user account of the cloud gaming server to the user account of the gaining platform using the received user credentials. Responsive to receiving a selection of a game associated with the gaming platform, the computing device may generate a platform-agnostic game shortcut of the selected game. Responsive to selecting the platform-agnostic game shortcut, the computing device may automatically launch a cloud gaming game instance of the game.

### CROSS-REFERENCE TO RELATED APPLICATION(S)

This application claims priority to provisional application No. 62/856,150, filed on Jun. 3, 2019, titled “Launch Game Shortcut from any Gaming Platform for Cloud Gaming” which are hereby incorporated by reference in their entirety.

### TECHNICAL FIELD

Embodiments of the present disclosure relate generally to generating a platform-agnostic game shortcut that, upon selection, automatically launches a cloud gaming game instance of a game. Examples of generating a platform-agnostic game shortcut outside of a cloud gaming server, and automatically launching a game responsive to selecting the platform-agnostic game shortcut, are described.

### BACKGROUND

Cloud video gaming has seen a considerable rise in popularity in recent years due to the development of elastic resources and the continued growth of datacenters. Because cloud video gaming enables the offloading of various complex tasks that would normally take place on a computing device, such as high-definition 31) rendering, gone are the days of users being tethered to an annual video game console or PC upgrade in order to play the latest and greatest (and often most resource intensive) video games. Instead, with the advent of cloud video gaming, users can take advantage of powerful compute resources hosted in the cloud on a cloud gaming server to play the latest games, all while using their often old and/or outdated gaming devices (e.g., PCs, video game consoles, mobile devices, arcade cabinets, etc.).

This is because with cloud video gaming, users may access their own private virtual machine that may have cloud gaming server software installed, from their computing device. The cloud gaming server software may capture the screen and encode the captured images into a continuous game play video stream, and transmit the encoded game play video stream to a user's computing device. The user's computing device may then download the encoded game play video stream, decode the encoded game play video stream, and display the decoded game play video stream on the computing device. The cloud gaming server may then upload the user's input actions from the computing device to the user's virtual machine so that the user can control game play of the game rendered on the virtual machine.

Conventionally, once the user has launched the cloud gaming server and logged into their virtual desktop, the cloud gaming server allows the user to install any game they own from any gaming platform. A gaining platform is software that typically functions as a digital store and game library for a user to store games and launch a game. Once the user installs the game from the gaming platform, they can launch the game inside the virtual machine and start playing the game.

### SUMMARY

Embodiments described herein relate to systems and methods for generating a platform-agnostic game shortcut that, upon selection, automatically launches a cloud gaining game instance of a game. In some examples, a computing device communicatively coupled to a cloud gaming server via a network may receive a user input indicative of user credentials associated with a user account of the cloud gaming server. In some examples, the computing device may further receive a user input indicative of user credentials associated with a user account of a gaming platform hosted on or supported by the cloud gaming server.

In some examples, based on the received user credentials associated with the user account of the cloud gaming server and the received user credentials associated with the user account of the gaming platform hosted on the cloud gaming server, the computing device may bind the user account of the cloud gaming server to the user account of the gaming platform hosted on the cloud gaming server.

In some examples, binding the user account of the cloud gaming server with the user account of the gaming platform initiates connection between an API corresponding to the cloud gaming server and the gaming platform.

In some examples, responsive to receiving a user input indicative of selecting at least one game of a plurality of games of a game library of the gaming platform hosted on the cloud gaming server, the computing device may generate a platform-agnostic game shortcut of the selected at least one game at the computing device.

In some examples, responsive to receiving a user input indicative of selecting the platform-agnostic game shortcut of the at least one game, the computing device may automatically launch a cloud gaming game instance of the at least one game.

### BRIEF DESCRIPTION OF THE DRAWINGS

Reference is now made to the following descriptions taken in conjunction with the accompanying drawing, in which:

FIG. 1 is a schematic illustration of a platform-agnostic game shortcut generation system, arranged in accordance with examples described herein;

FIG. 2 is a schematic illustration of one example of a user interface illustrating at least one generated platform-agnostic game shortcut, arranged in accordance with examples described herein; and

FIG. 3 illustrates a flow chart of a method for generating and launching a platform-agnostic game shortcut, arranged in accordance with examples described herein.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Cloud video gaming has seen a considerable rise in popularity in recent years. Because cloud video gaming enables the offloading of various complex tasks that would normally take place on a computing device, gone are the days of users being tethered to an annual console upgrade in order to play resource-intensive video games. Conventionally, once a user has launched a cloud gaming server and logged into their virtual desktop, the cloud gaming server allows the user to install gaming platforms and any games they own that are stored in the gaming platform. A gaming platform is software that typically functions as a digital store and game library for a user to store and launch a game. Once the user installs the gaming platform and the games, they can launch a game inside the virtual machine and start playing the game.

While cloud video gaming enables use of selective older and/or outdated hardware to play resource-intensive games, it is not without its drawbacks. For example, there is considerable complexity involved for a user to connect to their cloud gaming server, then logging into a gaming platform, selecting a game to install from an often large and unorganized game library or catalog, and finally launching the game once located. This requires the user to manually perform each time-intensive and often laborious step. Even if the game is already installed on the cloud gaming server, the user will still have to manually connect to the cloud gaming server, manually find the game in the gaming platform, and launch the game. Accordingly, it would improve a user's gaming experience if a user could generate a game shortcut that, in some examples, would be displayed outside of the cloud gaming server for a user to automatically launch a game that, in some examples, the user owns or has access to, or has usage right for, from the gaining platform.

Accordingly, examples described herein are generally directed towards systems and methods for generating a platform-agnostic game shortcut to automatically launch a game for cloud video gaming. Advantageously, and in this regard, embodiments described herein enable improvement in cloud video gaming technology by enabling the generation of a platform-agnostic game shortcut of a game selected from a game library or a game catalog of a gaming platform hosted on a cloud gaming server. In some embodiments, the generation of the platform-agnostic game shortcut of the game may be generated by binding a user account of a gaining platform to a user account of a cloud gaming server. The binded account may allow the cloud gaming server to display the games the user owns outside of the cloud gaining server in a separate software client as a platform-agnostic game shortcut.

Advantageously, embodiments described herein enable further improvement in cloud video gaming technology by enabling the automatic launch of a game associated with the platform-agnostic game shortcut of the game. In some embodiments, the user can launch the shortcut of a game they (in some cases) already own from the gaming platform, to a cloud gaming server without the need to manually search for and select the game from a game library or game catalog within the gaming platform inside the cloud gaming server. In other words, the systems and methods described herein simplify the steps to launch a game (that in some cases) a user already owns from outside of the cloud gaming server and doing the installation and game launching steps automatically.

In some examples, a computing device communicatively coupled to a cloud gaming server via a network may receive a user input indicative of user credentials associated with a user account of the cloud gaming server. In some examples, the computing device may further receive a user input indicative of user credentials associated with a user account of a gaming platform hosted on or supported by the cloud gaming server. In some examples, if the gaming platform is not hosted on the server yet, it may be hosted by installing the gaming platform to the server as long as it's supported by the server (e.g. Linux server may not support a gaming platform that exclusively runs on Windows). Additionally, in some examples, the preparation of hosted gaming platform may be done as a part of the launching of game instance or done offline.

In some examples, the user credentials associated with the user account of the cloud gaming server, the user credentials associated with the user account of the gaming platform hosted on the cloud gaining server, or combinations thereof, may comprise user identification information data, user name data, email data, password data, payment information data, or combinations thereof.

In some examples, based on the received user credentials associated with the user account of the cloud gaining server and the received user credentials associated with the user account of the gaming platform hosted on the cloud gaming server, the computing device may bind the user account of the cloud gaming server to the user account of the gaming platform hosted on the cloud gaining server. In some examples, binding the user account of the cloud gaming server with the user account of the gaming platform initiates connection between an API corresponding to the cloud gaming server and the gaming platform.

In some examples, responsive to receiving a user input indicative of selecting at least one game of a plurality of games of a game library of the gaming platform hosted on the cloud gaming server, the computing device may generate a platform-agnostic game shortcut of the selected at least one game at the computing device. In some examples, a platform-agnostic game shortcut may be generated for a single game. In some examples, a platform-agnostic game shortcut may be generated for more than one game. In some examples, a platform-agnostic game shortcut may be generated for an entire game library or game catalog of games. In some examples, a platform-agnostic game shortcut may be generated for a first game supported by one game platform, and a second game supported by a second game platform. In some examples, a platform-agnostic game shortcut may be generated based on a recommendation list of the most popular games played by a user. In some examples, a platform-agnostic game shortcut may be generated based on a recommendation list of the most recently played games by the user. In some examples, a platform-agnostic game shortcut may be generated based on a recommendation list of the most recently played games, and/or the most popular games played by a user's friends. In some examples, a platform-agnostic game shortcut may be generated based on a recommendation list of the most popular games played by famous garners. In some examples, platform-agnostic game shortcuts may be generated based on various game genres (e.g., action, RPGs, simulation, sports, strategy, puzzle, shooter, racing, etc.), ESRB ratings (e.g., E, E10+, T, M, A, etc.), publisher (e.g., Ubisoft, Square Enix, Konami, Capcom, Nintendo, EA, Activision Blizzard, Take-Two interactive, etc.), and the like. As should be appreciated, any combination of shortcuts from various game platforms may be generated, and the above-described examples are in no way limiting.

In some examples, responsive to receiving a user input indicative of selecting the platform-agnostic game shortcut of the at least one game, the computing device may automatically launch a cloud gaming game instance of the at least one game.

In some examples, automatically launching the cloud gaming game instance of the at least one game is based at least on, the computing device automatically logging into the user account of the cloud gaming server.

In some examples, automatically launching the cloud gaming game instance of the at least one game is further based at least on, the computing device automatically logging into the gaming platform hosted on the cloud gaming server.

In some examples, automatically launching the cloud gaming game instance of the at least one game is further based at least on, the computing device automatically locating the at least one game of the plurality of games of the game library of the gaming platform hosted on the cloud gaming server.

In some examples, automatically launching the cloud gaming game instance of the at least one game is further based at least on, the computing device automatically launching the at least one game of the plurality of games of the game library of the gaming platform hosted on the cloud gaming server.

In some examples, automatically launching the cloud gaming game instance of the at least one game is further based at least on, the computing device installing the at least one game onto the cloud gaming server.

In some examples, automatically launching the cloud gaming game instance of the at least one game may be further based at least on, the computing device sending, via the API, a script file of the at least one game, to the gaming platform.

In some examples, where the gaming platform offers an application programming interface (API) to sign in, authenticate the user, and retrieve the user's game library systems and methods described herein may use this API to bind the gaming platform account to the cloud gaming server. Once the account is binded, the cloud gaming software client may retrieve the user's game list from the user's game library and display the game shortcuts which the user can use to launch their games.

In some examples, where the gaming platform does not offer an API to sign in, authenticate the user, and retrieve the user's game library systems and methods described herein may prompt the user for their game platform login information and use this information to log into the gaming platform on the cloud gaming server. Once the cloud gaming server has logged into the gaming platform, the cloud gaming server may relay the user's game library back to the cloud gaming software client to display the game shortcuts, which the user may use to launch their games.

In some examples, the systems and methods described herein can be implemented in numerous ways depending on the gaming platform used to bind to the cloud gaming server.

In some examples, when a platform-agnostic game shortcut is selected, the cloud gaming server will automatically launch the game from the gaming platform in the background. In some examples, once the game is launched, the user can start playing the game without managing the game library of the game platform from the cloud gaming server.

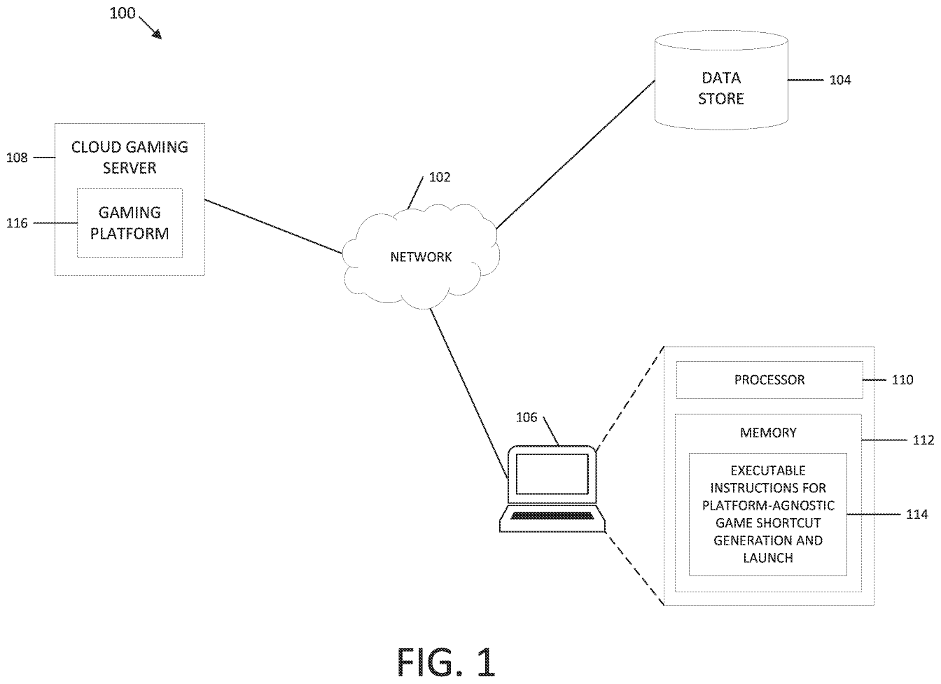

FIG. 1 is a schematic illustration of a platform-agnostic game shortcut generation and launch system 100 in accordance with examples described herein. It should be understood that this and other arrangements and elements (e.g., machines, interfaces, function, orders, and groupings of functions, etc.) can be used in addition to or instead of those shown, and some elements may be omitted altogether. Further, many of the elements described may be implemented as discrete or distributed components or in conjunction with other components, and in any suitable combination and location. Various functions described herein as being performed by one or more components may be carried out by firmware, hardware, and/or software. For instance, and as described herein, various functions may be carried out by a processor executing executable instructions stored in memory.

Among other components not shown, system 100 of FIG. 1 includes data store 104, computing device 106, and cloud gaming server 108. Computing device 106 includes processor 110 and memory 112. Memory 112 includes (e.g., may be encoded with) executable instructions for platform-agnostic game shortcut generation and launch 114. Cloud gaming server 108 includes gaining platform 116. It should be understood that system 100 shown in FIG. 1 is an example of one suitable architecture for implementing certain aspects of the present disclosure. Additional, fewer, and/or different components may be used in other examples. It should be noted that implementations of the present disclosure are equally applicable to other types of devices such as mobile computing devices and devices accepting gesture, touch, and/or voice input. Any and all such variations, and any combination thereof, are contemplated to be within the scope of implementations of the present disclosure. Further, although illustrated as separate components of computing device 106, any number of components can be used to perform the functionality described herein. Additionally, although illustrated as being a part of computing device 106, the components can be distributed via any number of devices. For example, processor 110 can be provided via one device, server, or cluster of servers, while memory 112 may be provided via another device, server, or cluster of servers.

As shown in FIG. 1, computing device 106 and cloud gaming server 108 may communicate with each other via network 102, which may include, without limitation, one or more local area networks (LANs) and/or wide area networks (WANs). Such networking environments are commonplace in offices, enterprise-wide computer networks, laboratories, homes, intranets, and the Internet (e.g., 5G, Wifi, etc.). Accordingly, network 102 is not further described herein. It should be understood that any number of computing devices and/or cloud gaming servers may be employed within system 100 within the scope of implementations of the present disclosure. With regard to computing device 106, it may comprise a single device or multiple devices cooperating in a distributed environment. For instance, computing device 106 could be provided by multiple server devices collectively providing the functionality of computing device 106 as described herein. Additionally, other components not shown may also be included within the network environment.

Computing device 106 and cloud gaming server 108 may have access (via network 102) to at least one data store or repository, such as data store 104, which may include user credentials (e.g., user credential data) associated with a user account of a cloud gaming server, user credentials (e.g., user credential data) associated with a user account of a gaming platform hosted on the cloud gaming server, and/or any accompanying metadata. For example, data related to user credentials associated with a user account of a cloud gaming server and/or user credentials associated with a user account of a gaming platform hosted on the cloud gaming server may include user identification info nation data, user name data, email data, password data, payment information data, other financial data, other contact information data, and related metadata.

In some examples, data store 104 may include additional data related to game data associated with various gaming platforms hosted on a cloud gaming server. In some examples, such data included in data store 104 may include data related to any and all games found in a user's game catalog or game library corresponding to a game platform, data related to a user's friends list associated with a game platform, and data related to various user reviews and reviews left by other users associated with specific games on a game platform, as well as all accompanying metadata. In implementations of the present disclosure, data store 104 may be searchable for any of the data and/or metadata described herein.

Such information (e.g., data and/or metadata) stored in data store 104 may include a plurality of unrelated data repositories or sources within the scope of embodiments of the present technology and disclosure. Data store 104 may be local to computing device 106 or cloud gaming server 108. Data store 104 may be updated at any time, including an increase and/or decrease in the amount and/or types of data related to any of the data and/or metadata described herein.

Examples described herein may include computing devices, such as computing device 106 of FIG. 1. Computing device 106 may be implemented using or more computers, servers, smartphones, smart devices, tablets, arcade cabinets, and/or the like. In some examples, computing device 106 may generate a game shortcut of the selected at least one game at the computing device. In some examples, computing device 106 may, responsive to receiving a user input indicative of selecting the game shortcut of the at least one game, automatically launch a cloud gaming cloud gaming game instance of the at least one game.

Computing device 106 may include computer readable media encoded with executable instructions, and a processor that may execute the instructions to provide platform-agnostic game shortcut generation and launch. As described herein, computing device 106 includes processor 110 and memory 112. Memory 112 includes executable instructions for platform-agnostic game shortcut generation and launch 114. In some examples, computing device 106 may be communicatively coupled to cloud gaming server 108 via a network, as well as gaming platform 116 via a network, such as network 102.

Computing devices, such as computing device 106 described herein may include one or more processors, such as processors, such as processor 110. Any kind and/or number of processors may be present, including one or more central processing unit(s) (CPUs), graphics processing units (GPI's), other computer processors, mobile processors, digital signal processors (DSPs), microprocessors, computer chips, and/or processing units configured to execute machine-language instructions and process data, such as executable instructions for platform-agnostic game shortcut generation and launch 114.

Computing devices, such as computing device 106 described herein, may further include memory 112. Any type or kind of memory may be present (e.g., read only memory (ROM), random access memory (RAM), solid state drive (SSD), and secure digital card (SD card). While a single box is depicted as memory 112, any number of memory devices may be present. Memory 112 may be in communication (e.g., electrically connected) to processor 110.

Memory 112 may store executable instructions for execution by processor 110, such as executable instructions for platform-agnostic game shortcut generation and launch 114. Processor 110, being be communicatively coupled (e.g., over a network, over a data network) to cloud gaming server 108 (and gaining platform 116), and via the execution of executable instructions for platform-agnostic game shortcut generation and launch 114, may connect computing device 106 to cloud gaming server 108 and gaming platform 116 to generate a platform-agnostic game shortcut to automatically launch a game for cloud video gaming at computing device 106.

More particularly, and based in part on processor 110 executing executable instructions for platform-agnostic game shortcut generation and launch 114, computing device 106 may receive a user input indicative of user credentials associated with a user account of a cloud gaming server, such as cloud gaming server 108. As described herein, in some examples, the user credentials associated with the user account of the cloud gaming server (such as cloud gaming server 108) may comprise user identification information data, user name data, email data, password data, payment information data, or combinations thereof.

Based in part on processor 110 executing executable instructions for platform-agnostic game shortcut generation and launch 114, computing device 106 may further receive a user input indicative of user credentials associated with a user account of a gaming platform (such as gaming platform 116) hosted on cloud gaming server 108. As described herein, in some examples, the user credentials associated with a user account of the gaming platform (such as gaming platform 116) may comprise user identification information data, user name data, email data, password data, payment information data, or combinations thereof.

Based in part on processor 112 executing executable instructions for platform-agnostic game shortcut generation and launch 114, based on the received user credentials associated with the user account of the cloud gaming server (such as cloud gaming server 108) and the received user credentials associated with the user account of the gaining platform (such as game platform 116) hosted on the cloud gaming server, computing device 106 may bind the user account of the cloud gaming server to the user account of the gaming platform hosted on the cloud gaming server. In some examples, binding the user account of cloud gaming server 108 with the user account of gaming platform 116 initiates connection between an API corresponding to cloud gaming server 108 and gaming platform 116.

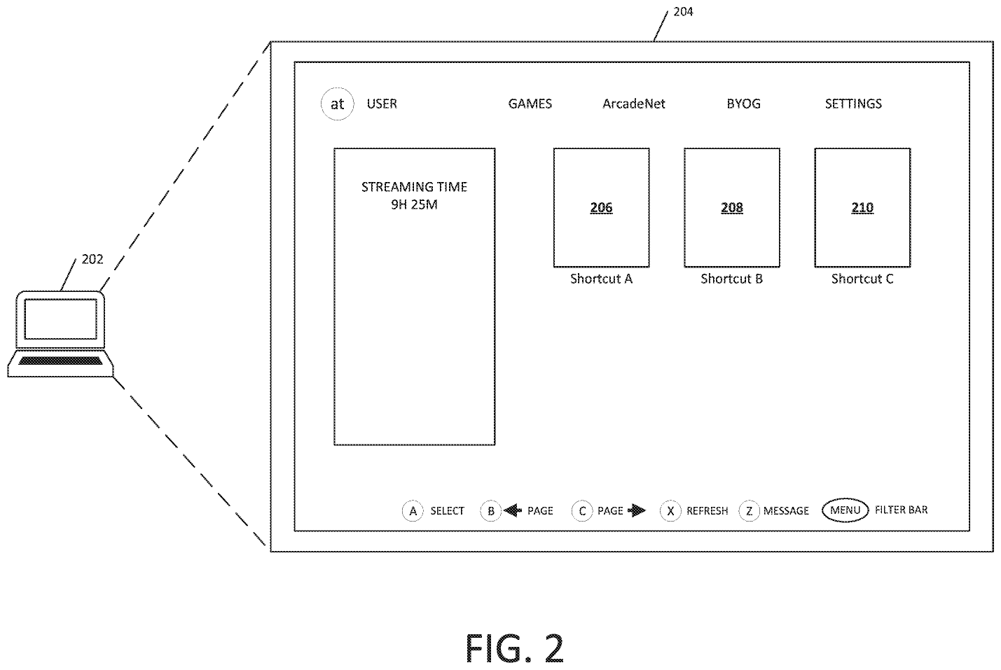

Based in part on processor 112 executing executable instructions for platform-agnostic game shortcut generation and launch 114, responsive to receiving (at computing device 106) a user input indicative of selecting at least one game of a plurality of games of a game library of the gaming platform hosted on the cloud gaming server, computing device 106 may generate a platform-agnostic game shortcut of the selected at least one game at the computing device. By way of example and not limitation, platform-agnostic shortcuts may include game shortcut 206, game shortcut 208, and game shortcut 210 of FIG. 2.

Based in part on processor 112 executing executable instructions for platform-agnostic game shortcut generation and launch 114, responsive to receiving (at computing device 106) a user input indicative of selecting the platform-agnostic game shortcut of the at least one game, computing device 106 may automatically launch a cloud gaining game instance of the at least one game. In some examples, automatically launching the cloud gaming game instance of the at least one game is based at least on, computing device 106 automatically logging into the user account of cloud gaming server 108. In some examples, automatically launching the cloud gaming game instance of the at least one game is further based at least on, computing device 106 automatically logging into gaming platform 116 hosted on cloud gaming server 108.

In some examples, automatically launching the cloud gaming game instance of the at least one game is further based at least on, computing device 106 automatically locating the at least one game of the plurality of games of the game library of gaming platform 116 hosted on cloud gaming server 108. In some examples, automatically launching the cloud gaming game instance of the at least one game is further based at least on, computing device 106 automatically launching the at least one game of the plurality of games of the game library of gaming platform 116 hosted on cloud gaming server 108. In some examples, automatically launching the cloud gaming game instance of the at least one game is further based at least on, computing device 106 installing the at least one game onto cloud gaming server 108. In some examples, automatically launching the cloud gaming game instance of the at least one game may be further based at least on, computing device 106 sending, via the API, a script file of the at least one game, to gaining platform 116.

In some examples, where gaming platform 116 offers an application programming interface (API) to sign in, authenticate the user, and retrieve the user's game library, computing device 106 may use this API to bind the gaming platform account (e.g., user account of the gaming platform) to the cloud gaming server (e.g., user account of the cloud gaming server). Once the account is binded, the cloud gaming software client may retrieve the user's game list from the user's game library and display the game shortcuts Which the user can use to launch their games

In some examples, where gaming platform 116 does not offer an API to sign in, authenticate the user, and retrieve the user's game library computing device 106 may prompt the user for their game platform login information and use this information to log into gaming platform 116 on cloud gaming server 108, Once cloud gaming server 108 has logged into gaming platform 116, cloud gaming server 108 may relay the user's game library back to the cloud gaming software client to display the game shortcuts at computing device 106, which the user may use to launch their games.

Based in part on processor 112 executing executable instructions for platform-agnostic game shortcut generation and launch 114, in some examples, when a platform-agnostic game shortcut is selected, cloud gaming server 108 will automatically launch the game from gaming platform 116 in the background. In some examples, once the game is launched, the user can start playing the game without managing the game library of game platform 116 from cloud gaming server 108.

Examples of cloud gaming servers, such as cloud gaming server 108, described herein may include, for example, any cloud gaming server that is capable of performing computationally complex tasks that support the local game play and execution of computationally expensive games installed on a cloud gaming server, on a computing device, such as computing device 106. While no components of cloud gaming server 108 are shown, it should be understood that in some embodiments, cloud gaming server may include a command (input/output) receiver, game logic, game instance of a game renderer, audio encoder, video encoder, video streamer, and any other components suitable for proper operation of a cloud gaming server, such as cloud gaming server 108. Examples of cloud gaming server 108 may include, but are not limited to, AWS, Paperspace, Azure, Softlayer, BOYG, and the like. In some examples, games may be installed on cloud gaming server 108 via various gaming platforms, such as Steam, Origin, GOG, UPlay, Battle.net, Epic, and the like. As should be appreciated, other methods for installing and storing games in a cloud gaming server, such as cloud gaming server 108, are contemplated to be within the scope of this disclosure.

Examples of gaming platforms, such as gaining platform 116, described herein may include, for example, any gaming platform that comprises software that typically functions as a digital store and game library for a user to launch a game. Examples of gaming platform 116 may include, but are not limited to, Steam, Origin, GOG, UPlay, Battle.net, Epic, and the like. While no components of gaming platform 116 are shown, it should be understood that in some embodiments, gaming platform 116 may include any components suitable for viewing, download, and storing video games (via catalogs and libraries), as well as in some cases, creating friend groups, writing reviews of games, and the like.

Turing now to FIG. 2, FIG. 2 is a schematic illustration of one example of a user interface illustrating at least one generated platform-agnostic game shortcut, arranged in accordance with examples described herein.

FIG. 2 includes computing device 202, display 204, and game shortcuts 206-210. As described herein, computing device 202 may generate a platform-agnostic game shortcut for launching a game outside of a cloud gaming server. In some examples, and as described herein, responsive to receiving a user input indicative of selecting the platform-agnostic game shortcut of the at least one game, the computing device may automatically launch a cloud gaming game instance of the at least one game. As one example, responsive to receiving a user input indicative of selecting game shortcut 206, computing device 106 may automatically launch a cloud gaming game instance of a game associated with game shortcut 206. As should be appreciated, game shortcuts 206-210 are located for selection by a user on computing device 106 outside of cloud gaming server 108.

As described herein, automatically launching a cloud gaming game instance of the at least one game is based at least on the computing device automatically logging into the user account of the cloud gaming server, the computing device automatically logging into the gaming platform hosted on the cloud gaming server, the computing device automatically locating the at least one game of the plurality of games of the game library of the gaming platform hosted on the cloud gaming server, the computing device automatically launching the at least one game of the plurality of games of the game library of the gaming platform hosted on the cloud gaming server, the computing device installing the at least one game onto the cloud gaming server, or combinations thereof.

To further the above example, automatically launching a cloud gaming game instance of a game associated with game shortcut 206 may be based at least in part on computing device 106 automatically launching cloud gaming server 108, computing device 106 automatically launching gaming platform 116, automatically locating the game associated with game shortcut 206, and launching the game associated with game shortcut 206.

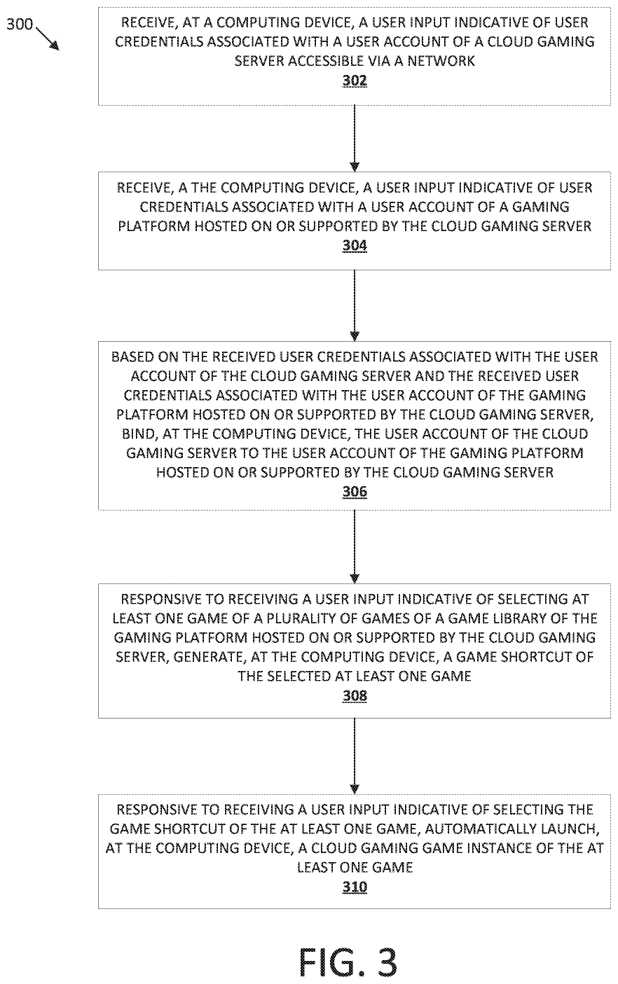

Turning now to FIG. 3, FIG. 3 is a flowchart of a method 300 arranged in accordance with examples described herein. The method 300 may be implemented, for example, using system 100 of FIG. 1.

The method 300 includes receiving, at a computing device, a user input indicative of user credentials associated with a user account of the cloud gaming server assessable via a network at block 302, receiving, at the computing device, a user input indicative of user credentials associated with a user account of a gaming platform hosted on the cloud gaming server at block 304, based on the received user credentials associated with the user account of the cloud gaming server and the received user credentials associated with the user account of the gaming platform hosted on the cloud gaming server, binding, at the computing device, the user account of the cloud gaming server to the user account of the gaming platform hosted on the cloud gaming server at block 306, responsive to receiving a user input indicative of selecting at least one game of a plurality of games of a game library of the gaming platform hosted on the cloud gaming server, generating, at the computing device, a game shortcut of the selected at least one game at block 308, and, responsive to receiving a user input indicative of selecting the game shortcut of the at least one game, automatically launching, at the computing device, a cloud gaming game instance of the at least one game at block 310.

Block 302 recites receiving, at a computing device, a user input indicative of user credentials associated with a user account of the cloud gaming server assessable via a network. As described herein, in some examples, the user credentials associated with the user account of the cloud gaming server may comprise user identification information data, user name data, email data, password data, payment information data, or combinations thereof.

Block 304 recites receiving, at the computing device, a user input indicative of user credentials associated with a user account of a gaming platform hosted on the cloud gaming server. As described herein, in some examples, the user credentials associated with the user account of the gaming platform hosted on the cloud gaming server may comprise user identification information data, user name data, email data, password data, payment information data, or combinations thereof.

Block 306 recites based on the received user credentials associated with the user account of the cloud gaming server and the received user credentials associated with the user account of the gaming platform hosted on the cloud gaming server, binding, at the computing device, the user account of the cloud gaming server to the user account of the gaming platform hosted on the cloud gaming server. As described herein, in some examples, binding the user account of the cloud gaming server with the user account of the gaming platform initiates connection between an API corresponding to the cloud gaming server and the gaming platform.

In some examples, where the gaming platform offers an application programming interface (API) to sign in, authenticate the user, and retrieve the user's game library systems and methods described herein may use this API to bind the gaming platform account to the cloud gaming server. Once the account is binded, the cloud gaming software client may retrieve the user's game list from the user's game library and display the game shortcuts which the user can use to launch their games

In some examples, where the gaming platform does not offer an API to sign in, authenticate the user, and retrieve the user's game library systems and methods described herein may prompt the user for their game platform login information and use this information to log into the gaming platform on the cloud gaming server. Once the cloud gaming server has logged into the gaming platform, the cloud gaming server may relay the user's game library back to the cloud gaming software client to display the game shortcuts, which the user may use to launch their games.

Block 308 recites responsive to receiving a user input indicative of selecting at least one game of a plurality of games of a game library of the gaming platform hosted on the cloud gaming server, generating, at the computing device, a game shortcut of the selected at least one game. As described herein, in some examples, a platform-agnostic game shortcut may be generated for a single game. In some examples, a platform-agnostic game shortcut may be generated for more than one game. In some examples, a platform-agnostic game shortcut may be generated for an entire game library or game catalog of games. In some examples, a platform-agnostic game shortcut may be generated for a first game supported by one game platform, and a second game supported by a second game platform. In some examples, a platform-agnostic game shortcut may be generated based on a recommendation list of the most popular games played by a user. In some examples, a platform-agnostic game shortcut may be generated based on a recommendation list of the most recently played games by the user. In some examples, a platform-agnostic game shortcut may be generated based on a recommendation list of the most recently played games, and/or the most popular games played by a user's friends. In some examples, a platform-agnostic game shortcut may be generated based on a recommendation list of the most popular games played by famous garners. In some examples, platform-agnostic game shortcuts may be generated based on various game genres (e.g., action, RPGs, simulation, sports, strategy, puzzle, shooter, racing, etc.). ESRB ratings (e.g., E, E10+, T, M, A, etc.), publisher (e.g., Ubisoft, Square Enix, Konami, Capcom, Nintendo, EA, Activision Blizzard, Take-Two Interactive, etc.), and the like. As should be appreciated, any combination of shortcuts from various game platforms may be generated, and the above-described examples are in no way limiting.

Block 310 recites responsive to receiving a user input indicative of selecting the game shortcut of the at least one game, automatically launching, at the computing device, a cloud gaming game instance of the at least one game. As described herein, in some examples, automatically launching the cloud gaming game instance of the at least one game is based at least on, the computing device automatically logging into the user account of the cloud gaming server. In some examples, automatically launching the cloud gaming game instance of the at least one game is further based at least on, the computing device automatically logging into the gaming platform hosted on the cloud gaming server. In some examples, automatically launching the cloud gaming game instance of the at least one game is further based at least on, the computing device automatically locating the at least one game of the plurality of games of the game library of the gaming platform hosted on the cloud gaming server.

In some examples, automatically launching the cloud gaming game instance of the at least one game is further based at least on, the computing device automatically launching the at least one game of the plurality of games of the game library of the gaming platform hosted on the cloud gaming server. In some examples, automatically launching the cloud gaming game instance of the at least one game is further based at least on, the computing device installing the at least one game onto the cloud gaming server. In some examples, automatically launching the cloud gaming game instance of the at least one game may be further based at least on, the computing device sending, via the API, a script file of the at least one game, to the gaming platform.

From the foregoing it will be appreciated that, although specific embodiments of the invention may have been described herein for purposes of illustration, various modification may be made without deviating from the scope of the invention.

The particulars shown herein are by way of example and for purposes of illustrative discussion of the preferred embodiments of the present invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a while and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

While various drawbacks of existing systems and possible advantages of examples described herein are discussed herein, it is to be understood that these drawbacks and possible advantages are provided to facilitate appreciation of the described examples only. Not all examples of the described technology may address all, or any, of the described drawbacks. Similarly, not all examples of the described technology may have all, or nay, of the described advantages.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system comprising:
a network configured to facilitate communication between a computing device and a cloud gaming server;
the computing device configured to:
receive a user input indicative of user credentials associated with a user account of the cloud gaming server;
receive a user input indicative of user credentials associated with a user account of a gaming platform hosted on or supported by the cloud gaming server;
based on the received user credentials associated with the user account of the cloud gaming server and the received user credentials associated with the user account of the gaining platform hosted on or supported by the cloud gaming server, binding the user account of the cloud gaming server to the user account of the gaming platform hosted on or supported by the cloud gaming server;
responsive to receiving a user input indicative of selecting at least one game of a plurality of games of a game library of the gaming platform hosted on or supported by the cloud gaming server, generate a game shortcut of the selected at least one game at the computing device; and
responsive to receiving a user input indicative of selecting the game shortcut of the at least one game, automatically launch a cloud gaming game instance of the at least one game on the cloud gaming server.

2. The system of claim 1, wherein automatically launching the cloud gaming game instance of the at least one game is based at least on, automatically logging into the user account of the cloud gaming server.

3. The system of claim 1, wherein automatically launching the cloud gaming game instance of the at least one game is further based at least on, automatically logging into the gaming platform hosted on or supported by the cloud gaming server.

4. The system of claim 1, wherein automatically launching the cloud gaming game instance of the at least one game is further based at least on, automatically locating the at least one game of the plurality of games of the game library of the gaming platform hosted on or supported by the cloud gaining server.

5. The system of claim 1, wherein automatically launching the cloud gaming game instance of the at least one game is further based at least on, automatically launching the at least one game of the plurality of games of the game library of the gaming platform hosted on or supported by the cloud gaming server.

6. The system of claim 1, wherein automatically launching the cloud gaming game instance of the at least one game is further based at least on, installing the at least one game onto the cloud gaming server.

7. The system of claim 1, wherein binding the user account of the cloud gaming server with the user account of the gaming platform initiates connection between an API corresponding to the cloud gaming server and the gaming platform, and wherein automatically launching the cloud gaming game instance of the at least one game is further based at least on, sending, via the API, a script file of the at least one game, to the gaming platform.

8. The system of claim 1, wherein the user credentials associated with the user account of the cloud gaining server, the user credentials associated with the user account of the gaming platform hosted on or supported by the cloud gaming server, or combinations thereof, comprise user identification information data, user name data, email data, password data, payment information data, or combinations thereof.

9. A method comprising:
receiving, at a computing device, a user input indicative of user credentials associated with a user account of a cloud gaming server accessible via a network;
receiving, at the computing device, a user input indicative of user credentials associated with a user account of a gaming platform hosted on or supported by the cloud gaming server;
based on the received user credentials associated with the user account of the cloud gaming server and the received user credentials associated with the user account of the gaming platform hosted on or supported by the cloud gaming server, binding, at the computing device, the user account of the cloud gaming server to the user account of the gaming platform hosted on or supported by the cloud gaming server;
responsive to receiving a user input indicative of selecting at least one game of a plurality of games of a game library of the gaming platform hosted on or supported by the cloud gaming server, generating, at the computing device, a game shortcut of the selected at least one game; and
responsive to receiving a user input indicative of selecting the game shortcut of the at least one game, automatically launching, at the computing device, a cloud gaming game instance of the at least one game on the cloud gaming server.

10. The method of claim 9, wherein automatically launching the cloud gaming game instance of the at least one game is based at least on, automatically logging into the user account of the cloud gaming server.

11. The method of claim 9, wherein automatically launching the cloud gaming game instance of the at least one game is further based at least on, automatically logging into the gaming platform hosted on or supported by the cloud gaming server.

12. The method of claim 9, wherein automatically launching the cloud gaming game instance of the at least one game is further based at least on, automatically locating the at least one game of the plurality of games of the game library of the gaming platform hosted on or supported by the cloud gaming server.

13. The method of claim 9, wherein automatically launching the cloud gaming game instance of the at least one game is further based at least on, automatically launching the at least one game of the plurality of games of the game library of the gaming platform hosted on or supported by the cloud gaming server.

14. The method of claim 9, wherein automatically launching the cloud gaining game instance of the at least one game is further based at least on, installing the at least one game onto the cloud gaming server.

15. The method of claim 9, wherein binding the user account of the cloud gaming server with the user account of the gaming platform initiates connection between an API corresponding to the cloud gaming server and the gaming platform, and wherein automatically launching the game instance of the at least one game is further based at least on, sending, via the API, a script file of the at least one game, to the gaming platform.

16. A non-transitory computer readable medium having computer-executable instructions stored thereon that, if executed by one or more processors of a computing device, cause the computing device to perform one or more steps comprising:
receiving a user input indicative of user credentials associated with a user account of a cloud gaming server assessable via a network;
receiving a user input indicative of user credentials associated with a user account of a gaming platform hosted on the cloud gaming server;
based on the received user credentials associated with the user account of the cloud gaming server and the received user credentials associated with the user account of the gaining platform hosted on or supported by the cloud gaming server, binding the user account of the cloud gaming server to the user account of the gaming platform hosted on or supported by the cloud gaining server;
responsive to receiving a user input indicative of selecting at least one game of a plurality of games of a game library of the gaming platform hosted on the cloud gaming server, generating a game shortcut of the selected at least one game; and
responsive to receiving a user input indicative of selecting the game shortcut of the at least one game, automatically launching a cloud gaining game instance of the at least one game on the cloud gaming server.

17. The computer readable media of claim 16, wherein automatically launching the cloud gaining game instance of the at least one game is based at least on, automatically logging into the user account of the cloud gaining server.

18. The computer readable media of claim 16, automatically launching the cloud gaming game instance of the at least one game is further based at least on, automatically logging into the gaining platform hosted on or supported by the cloud gaming server.

19. The computer readable media of claim 16, wherein automatically launching the cloud gaming game instance of the at least one game is further based at least on, automatically locating the at least one game of the plurality of games of the game library of the gaming platform hosted on or supported by the cloud gaming server.

20. The computer readable media of claim 16, wherein automatically launching the cloud gaming game instance of the at least one game is further based at least on, automatically launching the at least one game of the plurality of games of the game library of the gaming platform hosted on or supported by the cloud gaming server.
